(19) United States
(12) Patent Application Publication
(10) Pub. No.: US 2011/0153405 A1
(43) Pub. Date: Jun. 23, 2011

(54) METHOD OF ADVERTISING AND A PORTABLE MEMORY DEVICE FOR USE AS AN ADVERTISING PLATFORM

(75) Inventors: Darwin Chen, Ladera Ranch, CA (US); Mark Leathem, Villa Park, CA (US)

(73) Assignee: Kingston Technology Company, Inc.

(21) Appl. No.: 12/644,900

(22) Filed: Dec. 22, 2009

(51) Int. Cl. G06Q 30/00; G06Q 50/00; G06F 3/048

(52) U.S. Cl. 705/14.34; 705/14.39; 705/14.7; 715/764

(57) ABSTRACT

A general media content advertising vehicle usable by a large number of advertisers and with exposure to a large and diverse consumer base whether such users have Internet access or are operating off-line, defined by a portable memory device (PMD) adapted to support advertising and content data of different media types.

### FIELD OF THE INVENTION

The invention relates to advertising and methods of generating revenue from the advertising of products and services.

### BACKGROUND

We are familiar with advertising in newsprint and magazines as well as on billboards. In each of these cases the user is a passive participant and the advertising material is in a sense pushed onto the user.

The same applies to radio and television, in which commercials are interspersed between the entertainment footage.

With the advent of the Internet, advertising provided the user with a degree of autonomy. In addition to pushing advertising onto the user in the form of pop-ups, access buttons, and Web site skins, the Internet also allowing users to pull down additional information by providing the user with the facility to click on buttons or select from drop-down menus.

The Web-based advertising approach however is premised on the idea that the user has access to the Internet.

Another approach to advertising can be found in the one-on-one advertising in which targeted customers are repeatedly exposed to a company's or a product's trademark. This approach can, for example, be found in the concept of gift items adorned with a company's logo. Thus balloons, pens, mouse pads, stress balls, etc., with a company's logo or product trademark, are commonly given away at conventions as a way of providing ongoing advertising targeting the public that visits the company's booth. It is thus limited to advertising to people that not only attend the convention but also specifically visit the booth of the company giving out the gift item.

More recently companies like StickyDrive have adapted the gift item concept to USB drives, in which a particular company's logo or the company's product logo is stored in the memory of the device in the form of one or more skins promoting the company or product e.g., by adopting a skin with the company's logo. This is described in published US patent application 20080250190 to Brian Johnson, published Oct. 9, 2008. This approach allows a company to hand out custom-made USB drives to customers visiting its booth as a gift item and provide advertising to the user once he or she plugs the device into a USB port. The USB drive also includes links to the company's Web site, thereby driving customers to its Web site when the USB device is plugged into a computer that has Internet access.

However, what is missing is a general advertising vehicle for a large number of advertisers, with a view to reaching out to a large consumer base in the form of customers purchasing portable storage media.

### SUMMARY OF THE INVENTION

According to the invention there is provided a general media content and advertising vehicle usable by any number of advertisers (typically in the form of company subscribers) wishing to reach out to a large consumer base by advertising to the users whether such users have Internet access or are operating off-line.

The method also provides an additional potential revenue source from end users of the portable memory device and/or from advertisers wishing to advertize on or through the memory device. By providing pre-installed data or on-line access to data that is of interest to the user the sale of portable memory devices gains value from the user's perspective since the memory device changes from a blank slate or one that simply has a file manager, to a device providing access to multi-media content. This creates the potential for commanding a higher sales price for the memory device or for gaining greater market share. From the perspective of potential advertisers, the general advertising platform offered by the present invention allows marketing of products to a new, broad spectrum of consumers.

According to the invention, there is provided a portable memory device (PMD) such as a USB drive, that is adapted to be connected to a processing device and that includes electronic advertising data from multiple parties, and players or tools such as music players, photograph viewers, text editors, backup software, etc. The parties may include a manufacturer of the PMD. The PMD may include its own user interface, which may be implemented as a graphical user interface (GUI). Preferably the PMD includes content data, which may include entertainment data, applications and offers or promotions. The entertainment data may include files of data in different formats, such as music files e.g., in .wav or .mp3 format; picture files e.g., in jpeg, pdf or tif format; movie clips, e.g., in mpeg format; documents etc. The offers or promotions may include songs, games, videos etc. or parts of songs, games or videos; magazine subscriptions; coupons etc. The GUI may include links for accessing at least some of the content data remotely. The GUI may also include Internet links, typically in the form of Web links. The PMD may be operable to launch a browser when an Internet link is clicked. The browser may be a browser that is installed on the processing device into which the PMD is plugged. Instead, a browser may be locally stored on the PMD or may be downloaded from a server. The PMD may be implemented to launch the browser automatically when the PMD is plugged into a processing device, if the processing device is detected to have Internet access, or the browser may be launched manually by the user e.g., by clicking an Internet link. The processing device may include a desktop computer, laptop, Personal Digital Assistant (PDA), etc.

The PMD may be adapted to launch an initial page including only advertising data relating to the manufacturer of the disk when the PMD is plugged into a processing device. The initial page or window may include links to other windows or to Web sites, which windows and sites may include third party advertising data. The links themselves may include advertising data of third parties, e.g., buttons defined by third party logos or names. The initial page may include multiple links, each dedicated to a particular third party and each adapted to download data provided by said third party, from a storage location on the PMD or from a storage location on the processing device or from a remote storage device connected to the processing device by an intranet or the Internet. The data may include advertising, e.g., one or more skins depicting the company or a product such as a logo or other trademark.

Some or all of the content data may be hidden from the user until the PMD is verified. Verification may include initial verification of the presence of a product identifier (PID) that resides on the PMD. Once the PMD is plugged into a processing device with Internet access (on-line access), a secondary verification may be performed in which the PID is compared to a vendor identifier (VID) that is located on a remote server that is accessible through the Internet. The user may be provided with an End User License Agreement (EULA) with a Terms Acceptance button. By accepting the terms the PMD pings the server, which checks the PID against the VID and once verified, sends back a confirmation message allowing the user to gain on-line functionality. The verification may involve sending back a user identifier (UID) that has to first be entered by the user into a designated field before access is granted to the on-line functionality. Prior to such verification the user may only have access to local content on the PMD.

Further, according to the invention, there is provided a method of advertising, comprising providing on a portable memory device (PMD) at least one of advertising data and content data from the manufacturer of the PMD and at least one of advertising data and content data from one or more third parties. The third parties may be product or service providers. The PMD, which may include a USB drive, may be used in an off-line mode or an on-line mode. The PMD is typically plugged into a processing device having a port for receiving the PMD, wherein in off-line mode the processing device is not connected to the Internet. In the on-line mode the processing device, which may be a desk top computer, laptop, or PDA or palm top device, is connected to the Internet. The PMD may be configured to recognize access to the Internet. The content data may include entertainment data, applications, and offers or promotions. The entertainment data may include files of data in different formats, such as music files e.g., in .wav or .mp3 format; picture files e.g., in jpeg, pdf or tif format; movie clips, e.g., in mpeg format; documents etc. The applications may include players and tools such as music players, photograph viewers, text editors, backup software, etc. The offers and promotions may include songs, games, videos etc. or parts of songs, games or videos; magazine subscriptions; coupons etc. At least one of the advertising data and content data of third parties may only be made available in on-line mode. The PMD preferably includes a user interface, which may be a graphical user interface (GUI). On-line mode may cause a browser to be launched by the PMD or a browser may be launched by a user from the GUI.

Still further, according to the invention, there is provided a method of advertising, comprising providing a PMD with a user interface and providing electronic advertising data from multiple advertisers on the PMD. The PMD may include one or more Internet links associated with multiple advertisers. The user interface may include a link for launching or downloading a browser. The one or more Internet links may provide access to pre-defined Internet sites for opening separate Web pages, which may include downloadable data. The PMD may also include content data stored on the PMD, which may include entertainment data, applications and offers or promotions. The entertainment data may include files of data in different formats, such as music files e.g., in .wav or .mp3 format; picture files e.g., in jpeg, pdf or tif format; movie clips, e.g., in mpeg format; documents etc. The applications may include players and tools such as music players, photograph viewers, text editors, backup software, etc. The offers and promotions may include songs, games, videos etc. or parts of songs, games or videos; magazine subscriptions; coupons etc. The user interface is typically implemented as a GUI for accessing the content data and downloadable data. The content data may include different sets of data, each in its own format. The content data may be selected using user-clickable links. The Internet and user-clickable links may include advertising material e.g., buttons in the form of third party logos. The third parties may be product or service providers. The PMD, which may include a USB drive, may be used in an off-line mode or an on-line mode. The PMD is typically plugged into a processing device having a port for receiving the PMD, wherein in off-line mode the processing device is not connected to the Internet. In the on-line mode the processing device, which may be a desktop computer, laptop, or palm top device, is connected to the Internet.

Still further, according to the invention, there is provided a method of doing business comprising offering advertising space on a portable memory device (PMD) to third parties, receiving advertising data or access information to third party content from at least one third party, providing advertising data from multiple parties on the PMD, and offering the PMD through regular distribution channels to at least one of retailers, wholesalers, and end users. The method may include providing links that are associated with the access information on the PMD for accessing advertising data on-line from one or more third parties. The offering of advertising space may be done by the manufacturer of the PMD and the manufacturer may be one of the parties that provides advertising data or access information. The PMD may comprise a USB drive, and providing the PMD may include the manufacturer of the PMD giving the PMD away or selling the PMD at a reduced cost compared to PMDs without third party advertising data and access information or selling the PMD at an increased cost based on the user desirable data provided on the PMD. The method may include obtaining advertising revenue from the at least one third party. The links may provide access to Web pages with product or service information. The Web pages may include on-line purchasing facilities allowing users to purchase goods or services on-line. The method may include obtaining revenue from the third party based on sales to users, e.g., a percentage of sales or a flat fee per transaction or a fee based on the number of PMDs available to end users or sold to end users at a particular point in time.

The method may include launching an initial page when the PMD is plugged into a processing device, the initial page including only advertising data from the manufacturer of the disk. The initial page may include links to other windows or to Web sites, which windows and sites may include third part advertising data. The links may include advertising data of third parties, e.g., buttons defined by third party logos or names. The initial page may include multiple links, each dedicated to a particular third party and each adapted to download data from said third party, from a storage location on the PMD or from a storage location on the processing device or from a remote storage device connected to the processing device by an intranet or the Internet. In order to avoid all content data or access information from being copied by another party, the PMD may be implemented as an authorized PMD in which at least some content or access information is hidden and accessible only upon verification of a product identifier (PID) provided on the PMD. The verification may include simply the verification of the existence of the PID on the PMD or may include a comparison of the PID with a remote identifier e.g., to a vendor identifier (VID) stored on a server that is accessible through the Internet. The PMD may be included in the software code on the PMD or may be a user readable identifier provided at the time of purchase of the PMD, e.g., on the inside of the PMD package, and may be unique to each PMD. In a user readable PMD the user may be prompted to enter the authentication code when the PMD is first plugged into a processing device, which may be a desktop computer, laptop, or palm top device, etc. Instead, the PMD may include software code for interacting on-line with a server to identify itself as an authentic PMD and thereby receive a verification response that unlocks the hidden data.

### BRIEF DESCRIPTION OF THE DRAWINGS

FIG. 1 shows an embodiment of a home screen as defined by a GUI for a PMD in accordance with the invention,

FIG. 2 shows an embodiment of a music player interface screen as defined by a GUI for a PMD in accordance with the invention,

FIG. 3 shows an embodiment of a photo viewer screen as defined by a GUI for a PMD in accordance with the invention,

FIG. 4 shows an embodiment of a document editing screen as defined by a GUI for a PMD in accordance with the invention, and

FIG. 5 shows a flow chart depicting the use of a PMD as an advertising medium in accordance with one embodiment of the invention.

### DETAILED DESCRIPTION OF THE PREFERRED EMBODIMENT

The advertising approach of the present invention lies in establishing a portable memory device that is connectable to a computer, to serve as an advertising vehicle for a broad range of third party advertisers such as manufacturers or service providers. The portable memory device, which includes a connector for connecting to a computer, e.g. a USB drive such as a memory stick with a Universal Serial Bus (USB) port, has the benefit that it travels with the user, thereby exposing the user to the advertisements on a repeated basis whenever the user plugs the portable memory device (PMD) into a computer, whether it be the user's own computer or a third party computer. This contrasts with Web advertising or billboards, which only provide fleeting exposure to the advertising message.

From the advertisers' perspective it therefore reaches out to a broad spectrum of customers since PMDs cut across large market segments, covering a wide range of age groups without being race, gender or culture specific. For purposes of this application the term computer will be used to cover any processing device, e.g. desktop computer, laptop, palmtop, Personal Digital Assistant (PDA), etc, or any other processor having a port for receiving the PMD.

The present invention therefore seeks to attract manufacturers and service providers from every marketing segment, be it the technical sector, clothing, toys, services aimed at the home or the business, or any other conceivable market

The invention is not limited to any particular implementation and can be implemented using any portable hardware device that defines a PMD and that can be programmed using any suitable set of programming tools known in the art.

The resultant features provided by the programmed PMD may also vary between embodiments. The present invention does not propose simply displaying one or more advertisements when the PMD is plugged into a computer but seeks to include features and material that the user will consider as a value add and will entice the user to retain the programmed content rather than simply deleting it.

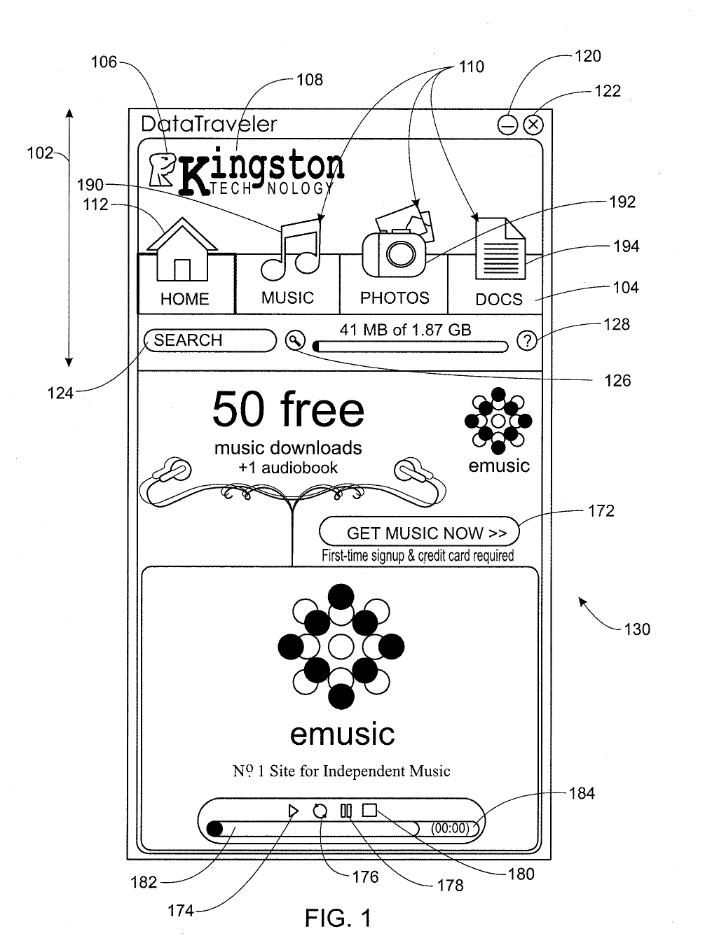

Since data corresponding to different types of media is preferably made accessible to the user, one embodiment of the PMD of the invention provides for different types of players or tools such as music players, video players, photograph viewers, text editors, backup software, etc., to be provided on the PMD. In order to simplify access to the different types of files stored on the PMD, the embodiment discussed below with respect to FIGS. 1-4 includes a user interface that is implemented as a graphical user interface (GUI), which may be launched automatically when the PMD is plugged into a compatible port on the computer. In this embodiment the PMD is comprises a Universal Serial Bus (USB) drive having a USB compatible interface that can simply be plugged into a USB port on the computer. In the embodiment illustrated in FIGS. 1-4, a GUI is provided that defines a set of selectable screens or windows. When the PMD of the present embodiment is plugged in, a home screen or window 100 is initially opened defining a primary skin. The various screens of this embodiment include an upper section 102 defining a tool bar 104 that remains unchanged. In this embodiment the upper section 102 also includes advertising of the PMD manufacturer, in the form of a background or skin that is indicative of the manufacturer of the PMD, and a logo 106 and company name 108. The tool bar 104 includes buttons 110 for selecting between different utilities or players. In this case the buttons are adapted to launch a new screen or window for each of a music player, photo viewer, and document text editor. In another embodiment, a video player is included. As shown in FIGS. 1-4, the tool bar 104 includes as its first button, a home button 112 allowing the user to return to the home page whenever he or she has selected one of the players.

The upper section 102 also includes a minimize button 120 and a close button 122. The bottom of the upper section is defined by a search window 124 for entering search terms, an enter or return button 126 and a memory capacity read-out 128.

The lower section 130 defined by the GUI differs for the home screen 100 and each of the

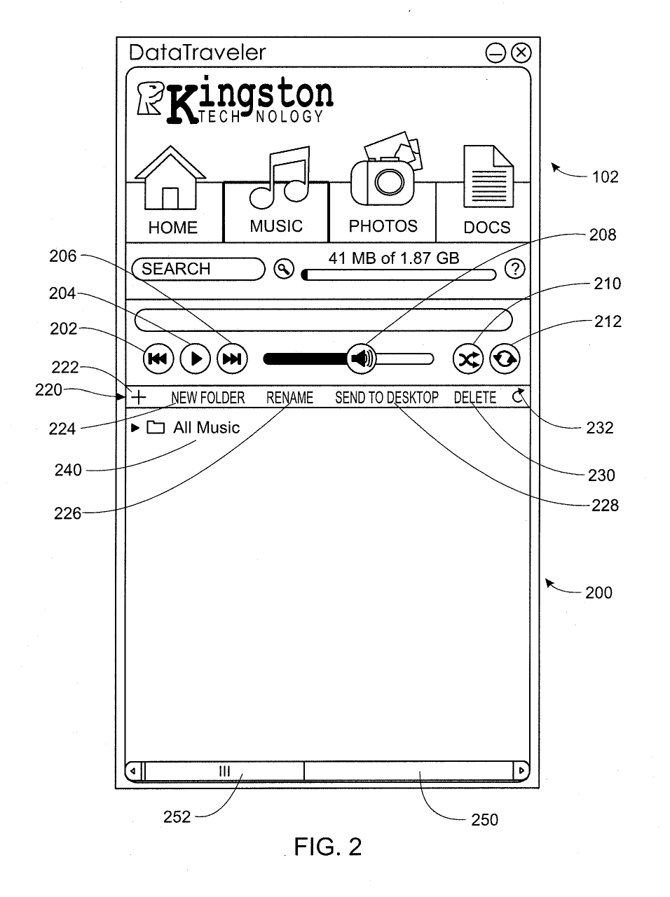

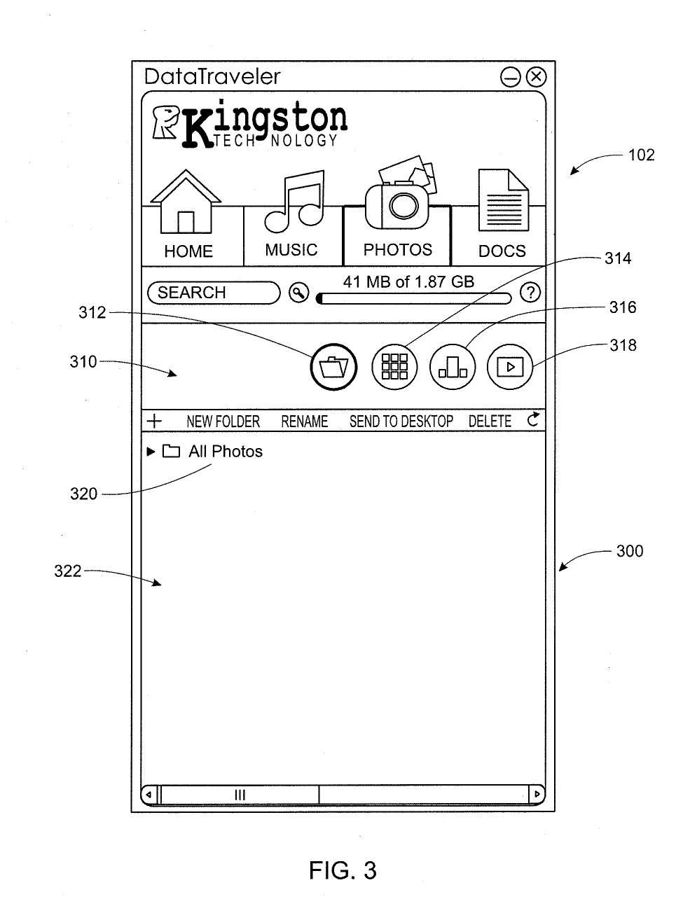

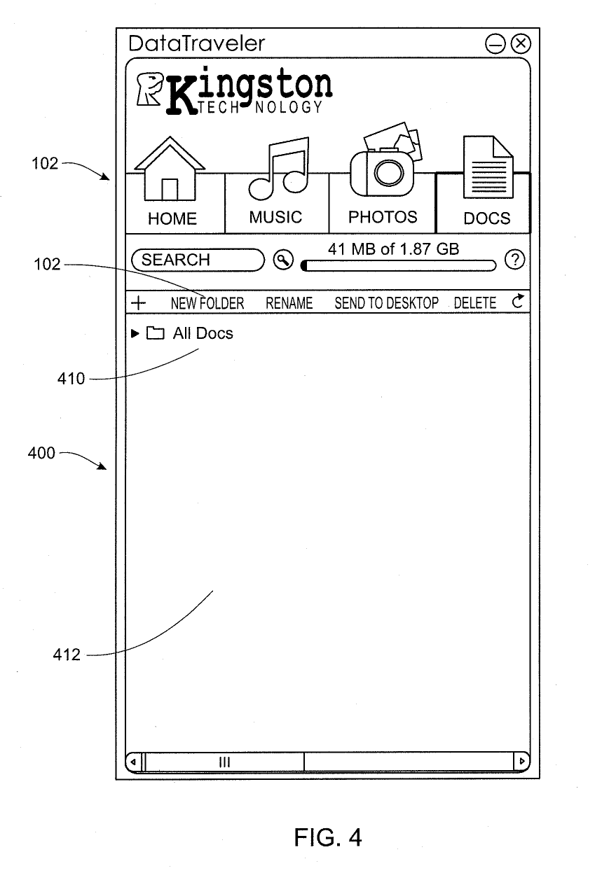

music player screen 200 shown in FIG. 2, the photo viewer screen 300 shown in FIG. 3, and the text editor screen 400 shown in FIG. 4. Thus clicking on any of the player buttons 110 brings up a new lower section, each or which will be discussed in turn below.

The lower section 130 of the home page 100, in this embodiment advertizes a promotional item in the form of free music downloads and an audio book. In order for the user to avail him-or-herself of the promotional item, a select button 172 is provided. The lower section 130 in this embodiment also includes a rudimentary music player with a play button 174, a loop button 176, a pause button 178 and a stop button 180. A progress bar 182 and progress counter 184 are also provided to indicate the length of the song and time remaining during play.

Selection of the music player using the music button 190 opens up a screen that remains unchanged as regards the top section 102 but defines a new lower section 200 as shown in FIG. 2. The lower section 200 includes music control buttons in the form of a rewind button 202, play button 204, fast forward button 206, a volume adjust slider 208, a shuffle select button 210, and a loop select button 212. For ease of use, in this embodiment the less commonly known buttons such as shuffle select and loop select include a descriptive title that appears then the cursor is positioned over the button in question. In addition to the player controls, the music player includes a file handling tool bar 220 that includes an Add Files button 222, a New Folder Selection button 224, a File Rename button 226, a Send to Desktop button 228 for sending a file to the desktop of the computer, a Delete button 230, and a Refresh button 232. A drop down menu 240 allows all music files to be displayed that are currently on the PMD. A slider bar 250 at the bottom of the screen allows the progress of the song to be monitored and allows the user to scroll forward or backward by adjusting the slider 252. It will be appreciated that since the PMD is plugged into a port of a computer, and the GUI on the PMD is adapted to be automatically launched when the device is plugged into the computer or is launched by the user accessing the PMD GUI program from his or her computer, the computer's screen serves as the display mechanism for the GUI and the computer mouse or other cursor control mechanism allows the user to interact with the buttons and slide bars on the PMD GUI.

In the same way that the music player was launched by clicking on the music button 190, the photo viewer can be launched by clicking on the photo select button 192. Like the home page and the music player page, the photo viewer page has an upper section 102 that is the same for all of the pages or windows. The lower section 300 is unique to the photo viewer, in that it has a player tool bar 310 adapted for viewing photos. The tool bar 310 includes a folder view button 312, a thumbnail view button 314 for viewing thumbnail size versions of the photos on the PMD, a rollover select button 316 for selecting a rollover form of displaying the photos, and a slideshow view select button 318 to view photos as a slide show. It will be appreciated that for all of these players the embodiment described is illustrative of one embodiment only. Other players could be included and additional control buttons could be included. For instance, in a slideshow mode a time delay select feature could be included for defining the time between photos. In the photo viewer, there is also a general file display button 320 with a field 322 for displaying all of the photo files on the PMD.

The text editor is launched by clicking on the documents button 194. The resultant page or window includes an upper section 102 that remains unchanged from the other windows. Its lower section 400 does not include any play control tool bar or buttons but simply includes a general file display button 410 for displaying in the display area 412 all text document files currently on the PMD. In this embodiment the text editor is adapted to launch only .doc type files but other embodiments could support other text or graphic formats such as docx or pdf files.

It will be appreciated that none of the players described above are necessary for providing advertising on a memory device, however it is part of the feature set that is included in order to create a user experience that persuades the user to retain all of this pre-installed content on the PMD notwithstanding that it uses up some of the memory space on the PMD.

In addition to the tools provided on the device, the PMD includes pre-programmed content data, which in FIG. 1 includes entertainment data in the form of promotional free video downloads. Other embodiments can include additional or different entertainment data such as video clips, photos and graphic images, and games.

The entertainment data in this embodiment inherently also provides an offer or promotion since only the first 50 downloads are free. The music provider is thus providing a loss-leader in an endeavor to attract new customer to his product offering. Promotions and offers could instead include coupons or special deals e.g., deals on travel. The offers or promotions may also include games, videos etc., or parts of songs, games or videos; magazine subscriptions; coupons etc. Thus, while the dividing line between promotions and pre-programmed content data may not always be clearly defined, the concept remains the same: to provide the user with something that is interesting or of value to the user, thereby enticing him or her to retain the pre-installed content together with the advertising material rather than simply deleting it all.

The entertainment data may include files of data in different formats, such as music files e.g., in .wav or .mp3 format; picture files e.g., in jpeg, pdf or tif format; movie clips, e.g., in mpeg format; documents etc. In order to allow such files to be opened even when the computer into which the PMD is plugged does not include the software that supports the different formats, players may specifically be included on the PMD to allow such files to be opened.

In the embodiment of FIG. 1, the advertising is not limited to pre-installed data but includes Internet links provided on the PMD, typically in the form of Web links. On the home page 100, the manufacturer's logo 106 is implemented as a hot button that provides a link to the manufacturer's Web site when the device is plugged into a computer that has Internet access. Similarly, the “Get Music Now” button 172 defines a button to the Web site of the music provider.

The PMD in this embodiment includes a pre-installed browser but could simply provide instructions for downloading full browser functionality from the computer or from a server via the Internet or an intranet or could make use of the browser installed on the computer or processing device into which the PMD is plugged.

The PMD in this embodiment is implemented to launch the browser automatically when the PMD is plugged into a processing device that has a port for receiving the PMD, if the processing device is detected to have Internet access.

In the embodiment of FIGS. 1-4, the PMD is adapted to launch an initial page (the home page 100), which includes advertising data related to the manufacturer of the PMD and advertising data of the provider of the promotional music data.

In a different embodiment, the GUI could be configured to display on the home page only material pertaining to the manufacturer of the PMD, with links on the home page to different players or items of interest that lead the user to pages related to other advertisers, referred to in this application as third party advertisers. In such an embodiment the initial page includes a first skin with a tool bar, and a second skin with links to other windows that are accessible using the pre-installed GUI. In such an embodiment, the initial page could include multiple links, each dedicated to a particular third party advertiser and each adapted to launch data provided by said third party and either stored in a storage location on the PMD or downloaded from a remote storage device, e.g., a server connected to the processing device by an intranet or the Internet. The subsequent windows and sites may include third party advertising data in the form of skins depicting company trademarks or logos or colors, similar to the logo 106 of the FIG. 1 embodiment. The links themselves can include advertising data of third parties.

The implementation of the drivers and GUI etc., can be performed using any suitable programming language, e.g., C++ for the file storage system and Adobe® Flash® software for the GUI and using programming technique as known in the art, e.g. using the approach defined by StickyDrive in US published patent application 20080250190 to Brian Johnson, published Oct. 9, 2008.

In order to avoid third party copying of the PMD content, at least some of the content data may be hidden and only become accessible upon verification of an verification code. In one embodiment, a product identifier (PID) is included in the software code on the PMD and serves as verification that the PMD is a genuine product and is not a competitor's PMD that has simply copied the content of the original PMD. In particular, the PID is provided in a part of the PMD that is not copyable by a data copy operation. Once the existence of a valid PID is verified (which marks the initial verification procedure), the rest of the launch operation is executed causing the GUI to be launched and on-chip data to be made available. Once the PMD is provided with on-line access, a secondary verification procedure is invoked. This includes comparison of the product identifier (PID) that resides on the PMD against a vendor identifier (VID) that is located on a remote server that is accessible through the Internet. The user may be provided with an End User License Agreement (EULA) with a Terms Acceptance button, which in this embodiment is launched once the PMD is determined to have on-line access. In another embodiment the EULA is made available once the GUI is first launched, allowing the user to accept the terms at any time thereafter. By accepting the terms of the EULA, the PMD pings a server, which checks the PID against the VID and once verified, sends back a confirmation message allowing the user to gain on-line functionality. The verification may involve sending back a user ID (UID) that has to first be entered by the user into a designated field before access is granted to the on-line functionality. Prior to such verification the user may only have access to local content on the PMD.

In another embodiment, a verification code may be provided at the time of purchase of the PMD, e.g., on the inside of the PMD package, and may be unique for each PMD. The user may be prompted to enter the authentication code when the PMD is first plugged into a processing device.

In order to promote the PMD e.g., a USB drive/memory stick as an advertising medium for third parties, the present invention includes making the PMD available at time of manufacture and thereafter for the inclusion of advertising material, promotional material and entertainment data. Third party advertisers are invited to provide one or more of such data items for inclusion on the PMD by storing entertainment data, promotional material and/or advertising on the PMD or by providing links on the PMD to allow the user subsequently to access any such data from third party advertisers' Web sites. By selling advertising space on the PMD, this may provide an additional revenue source to the manufacturer of the PMD. Promotional items and entertainment data may in turn increase the inherent value of the PMD to users and thereby provide a way of either gaining market share or increasing the price of the device. The particular marketing strategy can be adapted and changed depending on the nature of the content, the existing market share of the PMD manufacturer and other considerations.

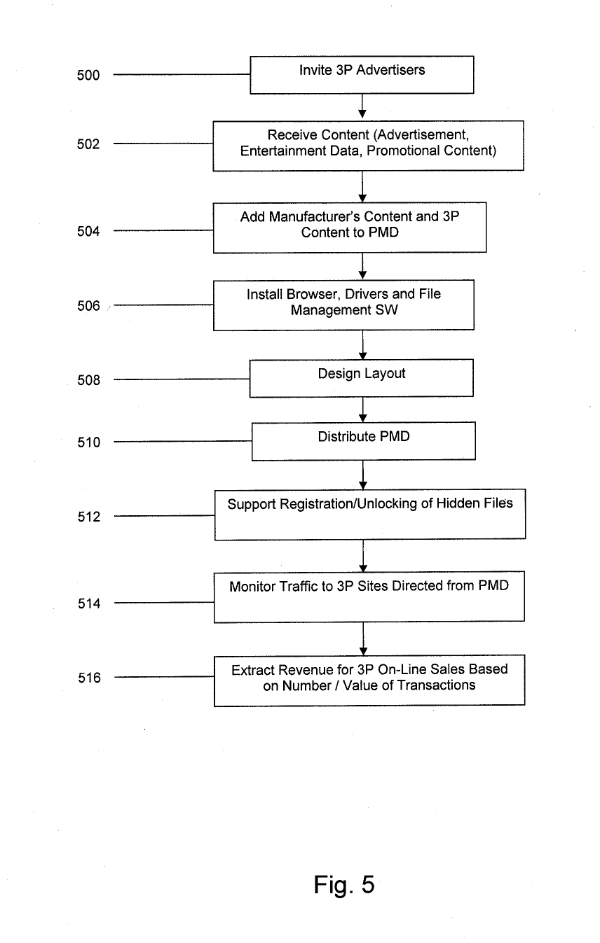

FIG. 5 shows a flow chart depicting one embodiment of the steps involved in the manufacture of a PMD of the invention by obtaining data for the PMD and populating the PMD with the data as part of the process of defining an advertising platform for third parties. In step 500 third parties (which typically include advertisers but can also include third part content providers) are invited to provide advertising data and preferably additional content that is of interest to end users. The data from each third party can be provided directly to the manufacturer of the PMD or can be made available by way of a Web link (step 502). The Web link may be provide by the manufacturer on the PMD for subsequent review or downloading of information by the user, or may be used by the manufacturer of the PMD to download certain content that is subsequently stored directly on the PMD. In step 504 the manufacturer provides its own content, and in steps 506 and 508, the manufacturer or a third party installer installs any utilities onto the PMD, defines the layout of the various windows on the PMD and adds the content from the third parties and the manufacturer. The PMD is then distributed via regular commercial channels, which may include retailers and wholesalers or direct sales to end users e.g., on-line sales of USB drives to end users (step 510). The sales price may be chosen to support a variety of marketing strategies and will typically depend on the nature and amount of useful content provided on the PMD. In one embodiment, the retail and wholesale channels could sell the PMDs at a premium price due to the valuable content on the PMD, or at a reduced price, in which case the revenue stream may be derived from the advertising provided on the PMD. As depicted by step 512 some or all of the user-valuable content may be hidden and may require unlocking by the user e.g. by registering the product and agreeing to an End User License Agreement (EULA). Steps 514 and 516 show yet further revenue streams that may be derived by the PMD manufacturer from an advertising platform of the invention. In this case the pass-throughs or hits to a third party Web site due to being directed from the PMD, may be monitored. This may, for example, be implemented by having links to the third party Web sites routed through the PMD manufacturer's server. The number of transactions (e.g. third party product sales) and amounts of such sales may also be monitored e.g., by placing cookies or other code on the server used by the third party for supporting its Web site. For instance a click on a banner advertisement, e.g., to take advantage of an offer to a promotional item may provide an automatic click-through to an advertiser's Web site. The advertising company providing the banner could be contractually required to track such click-throughs with an auditing provision allowing the manufacturer to occasionally audit the books of the advertiser. Coding can also be embedded in the banner advertisement with an identification number unique to the PMD manufacturer. An advertising company acting as a clearing house may then be tasked with monitoring the traffic to an advertiser's Web site to identify the traffic with the unique address.

In another embodiment an intermediate server is interspersed to relay any traffic from the PMD. This can be achieved by embedding code in the PMD for directing traffic (due to clicking on any of the links) to the intermediate server that acts as a router for receiving URL requests and relaying that request to the server designated by the URS. The intermediate server identifies the source of the request as a PMD and maintains a record of the pass-throughs by adding an additional pass-through to its tally. In the case of a transaction, e.g., an offer to buy something, this could trigger a further revenue stream to the manufacturer of the PMD based on the number of transactions that are concluded or the monetary value involved in the transaction. Software can be included on the PMD to allow credit card payment or the transaction can be handled by a third party entity such as PayPal. In one embodiment, Web analytics are performed to check whether the customer stays honest. This could involve accessing vendor reports as a form of checks and balances. Instead of monitoring transactions, an advertiser wishing to advertize on the PMD, e.g. by placing a banner advertisement that is viewable on all PMD's that are plugged into a computer with on-line access, can be required to pay a certain amount per defined number of PMD's that have been sold at a certain point in time, either to end users or retailers, e.g., $1 per million PMDs. The banner ad can then be pushed over the Internet onto each of the compatible PMDs.

The PMD itself could have an application store allowing a user to buy applications. The invention also envisages collecting revenue from the inclusion of software pre-loads on the PMD, e.g., the Bing search engine of Microsoft, thereby helping to grow the user base of the software. While the present invention has been described with respect to particular embodiments, it will be appreciated that the invention can be implemented in different ways without departing from the scope of the invention as defined by the claims.

The matter set forth in the foregoing description and accompanying drawings is offered by way of illustration only and not as a limitation. While particular embodiments have been shown and described, it will be appreciated that changes and modifications may be made without departing from the broader aspects of applicants' contribution.

What is claimed is:

1. A method of implementing advertising using data on a portable memory device (PMD) comprising
offering advertising space on the PMD to third parties,
receiving at least one of advertising data and content data from multiple third parties,
providing at least one of advertising and content data or links to at least one of advertising and content data from multiple parties on the PMD, and
selling the PMD through regular distribution channels to at least one of retailers, wholesalers, and end users.

2. A method of claim 1, further comprising providing on the PMD at least one of advertising and content data from the manufacturer of the PMD.

3. A method of claim 2, wherein the PMD comprises a USB drive.

4. A method of claim 2, wherein selling the PMD includes selling the PMD at a reduced cost compared to PMDs without third party advertising data and access information or selling the PMD at an increased cost based on the user desirable data provided on the PMD.

5. A method of claim 2, further comprising obtaining advertising revenue from the at least one third party.

6. A method of claim 1, wherein the links provide access to Web pages with product or service information.

7. A method of claim 6, wherein at least one of the Web pages includes on-line purchasing facilities allowing users to purchase goods or services on-line.

8. A method of claim 7, further comprising obtaining revenue from at least one third party based on one or more of user hits to the third party's Web site, and sales to users based on number of transactions or size of transactions.

9. A method of claim 1, wherein an initial page is launched when the PMD is plugged into a processing device.

10. A method of claim 9, wherein the initial page includes advertising data only from the manufacturer of the disk.

11. A method of claim 10, wherein the initial page includes links to other windows or to Web sites, which windows and Web sites include at least one of third party advertising and content data.

12. A method of claim 11, wherein the links are defined by buttons that include third party logos or names.

13. A method of claim 9, wherein the initial page includes multiple links, each dedicated to a particular third party and each adapted to download data from the third party, from a storage location on the PMD or from a storage location on the processing device or from a remote storage device connected to the processing device by an intranet or the Internet.

14. A method of claim 1, wherein the PMD is implemented as an authorized PMD in which at least some content data or links are hidden and accessible only upon authentication of the PMD.

15. A method of claim 14, wherein the authentication includes entering an authentication code that is provided at the time of purchase of the PMD.

16. A method of claim 15, wherein the user is prompted to enter the authentication code when the PMD is first plugged into a processing device.

17. A method of claim 14, wherein the PMD includes software code for interacting on-line with a server to identify itself as an authentic PMD and thereby receive a verification response that unlocks the hidden data.

18. A method of implementing advertising using data on a portable memory device (PMD), comprising
providing the PMD with a user interface, and
providing electronic advertising data from multiple advertisers on the PMD.

19. A method of claim 18, wherein the PMD includes one or more Internet links associated with the multiple advertisers.

20. A method of claim 19, wherein the user interface includes a link for launching or downloading a browser.

21. A method of claim 20, wherein the PMD also includes content data stored on the PMD.

22. A method of claim 21, wherein the content data includes at least one of entertainment data, applications and offers or promotions.

23. A method of claim 22, wherein the entertainment data includes data in different formats, including .wav or .mp3 format music files, jpeg, pdf or tif format picture files, mpeg format movie clips, and doc or docx or pdf documents.

24. A method of claim 22, wherein the applications include players and tools, including one or more of music players, photograph viewers, text editors, and backup software.

25. A method of claim 22, wherein the offers or promotions include songs, games, videos, or parts of songs, games or videos, magazine subscriptions, and coupons or rebates.

26. A method of claim 22, wherein the user interface is implemented as a GUI.

27. A method of claim 26, wherein the content data is selected using user-clickable links defined by buttons in the form of third party logos.

28. A method of claim 21, wherein the PMD is defined by a USB drive.

29. A method of claim 21, wherein the PMD is usable in an off-line mode or an on-line mode.

30. A portable memory device (PMD) such as a USB drive, that is adapted to be connected to a processing device comprising:
at least one of electronic advertising data and content data from multiple parties, and
players or tools.

31. A PMD of claim 30, wherein the players or tools include music players, photograph viewers, video players, text editors, and backup software.

32. A PMD of claim 31, wherein the parties include a manufacturer of the PMD.

33. A PMD of claim 29, further including a graphical user interface (GUI).

34. A PMD of claim 33, further including content data.

35. A PMD of claim 34, wherein the content data includes entertainment data, applications and offers or promotions.

36. A PMD of claim 35, wherein the content data includes files of different formats, including .wav or .mp3 format music files, jpeg, pdf or tif format picture files, mpeg format movie clips, and doc or docx or pdf documents.

37. A PMD of claim 36, wherein the offers or promotions include songs, games, videos, parts of songs, games or videos, magazine subscriptions, coupons and rebates.

38. A PMD of claim 37, wherein the PMD is operable to launch a browser that is locally stored on the PMD or is downloadable from a server.

39. A PMD of claim 38, wherein the PMD is adapted to launch an initial page or window including advertising data relating to the manufacturer of the PMD when the PMD is plugged into a processing device.

40. A PMD of claim 39, wherein the initial page or window includes links to other windows or to Web sites.

41. A PMD of claim 38, wherein the content data includes hidden data that is accessible only upon authentication of the PMD.

42. A PMD of claim 41, wherein the PMD includes software code for interacting on-line with a server to identify itself as an authentic PMD and thereby receive a verification response that unlocks the hidden data.
